(19) United States
(12) Patent Application Publication
(10) Pub. No.: US 2008/0062438 A1
(43) Pub. Date: Mar. 13, 2008

(54) Document resizer

(76) Inventors: Xiofan Lin, Fort Collins, CO (US); Carl Chow, Fort Collins, CO (US); Hui Chao, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/519,646

(22) Filed: Sep. 12, 2006

(51) Int. Cl. G06K 15/02

(52) U.S. Cl. 358/1.2; 358/452

(57) ABSTRACT

A method of resizing documents comprises obtaining a first bitmap document file corresponding to a first size document and identifying, in a single dimensional orientation, at least one whitespace portion between adjacent non-white portions in the first bitmap document file. A size of the at least one whitespace portion in the first bitmap document file in the single dimensional orientation is adjusted to produce a second bitmap document file corresponding to a second size document having a different size than the first size document.

### BACKGROUND

In this information age, documents travel rapidly to other countries or continents in the blink of an eye via electronic mail, facsimile, or other mechanisms. However, even rapid communication cannot overcome powerful differences between the cultures on different continents, which affect many aspects of daily life. Of course, the handling and printing of documents is no exception. For example, in North America, documents are typically formatted and printed in a U.S. Letter size of 8½ inches wide and 11 inches tall while documents in Europe are typically formatted and printed in an A4 size, which is about 8¼ inches wide and about 11⅔ inches tall. While documents can be printed in sizes other than U.S. Letter or A4, these sizes are the dominant formats. Convergence to a single standard is not expected any time soon.

Consequently, documents in one size or format are frequently converted to another size document or format. Even with such features available in document printing software, such as a conventional fit-to-paper feature, a considerable amount of time and energy is spent converting documents. In particular, a fit-to-paper solution results in enlarged top and bottom margins, or enlarged left and right margins, giving the resized document a distorted appearance. These margins can be adjusted manually through word processing software prior to printing; however, this process is time-consuming and costly when done on a large scale. Besides adjusting the margins of a document, multi-page documents may require adjustment of page numbers of one or more pages of the document to restore the nature of the original document.

Given the magnitude of this issue, meeting the challenge of document resizing effectively is in everyone's interest.

### SUMMARY

One embodiment of the invention is directed to a method of resizing documents. In one aspect, a method of resizing documents comprises obtaining a first bitmap document file corresponding to a first size document and identifying, along a single dimensional orientation, at least one whitespace portion between adjacent non-white portions in the first bitmap document file. A size of the at least one whitespace portion in the first bitmap document file is adjusted, in the single dimensional orientation, while maintaining a size of the non-white portions to produce a second bitmap document file corresponding to a second size document having a different size than the first size document.

### BRIEF DESCRIPTION OF THE DRAWINGS

FIG. 1 is a block diagram of a document resizer, according to an embodiment of the present invention.

FIG. 2 is a diagram illustrating documents handled by a document resizer, according to an embodiment of the present invention.

FIG. 3 is a flow diagram of a method of resizing documents, according to an embodiment of the present invention.

FIG. 4 is a diagram illustrating application of a method document resizing, according to an embodiment of the present invention.

FIG. 5 is a diagram illustrating application of a method document resizing, according to an embodiment of the present invention.

FIG. 6 is block diagram of a conversion monitor, according to an embodiment of the present invention.

FIG. 7 is a diagram illustrating results of document resizing, according to an embodiment of the present invention.

### DETAILED DESCRIPTION

In the following detailed description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

Embodiments of the present invention are directed to automatically resizing documents from one size to another while maintaining the look and feel of the original size document. This feature is enabled by adjusting the size of whitespace portions between lines of text and/or between graphic objects in a bitmap document file along a single dimensional orientation. For example, in a document having horizontally extending lines of text, the horizontally extending white spaces that vertically separate the lines of text (i.e., intervening whitespaces) are adjusted by changing a vertical dimension of the intervening whitespaces. A similar adjustment is made for documents having vertically arranged lines of symbols, such as an Asian language document, except that a horizontal size of intervening whitespace portions (i.e., the space between portions that extend vertically between vertically extending lines of text or objects) is changed instead of changing the vertical size of horizontally extending whitespace portions.

In order to increase a vertical dimension of whitespace portions in a document, such as when converting from a U.S. Letter size to an A4 size, the size of the intervening whitespace portions is increased in proportion to a height/width aspect ratio of one document size relative to the other document size. In order to decrease a vertical dimension of a document, such as when converting from an A4 to a U.S. Letter size, the size of the intervening whitespace portions are decreased in proportion to a height/width aspect ratio of one document size relative to the other document size. In one aspect, a resolution of the document file (e.g., a capture resolution, such as used in scanning or rasterization) is accounted for while balancing the aspect ratios of the two different document sizes.

The resizing of documents is applied to paper documents and/or electronic documents, such as those displayed on a display screen of a computer or other electronic device.

Embodiments of the invention enable document resizing without complex analysis, coordinate repositioning of text or objects, and/or without resizing of text characters. Instead, documents are resized by automatic adjustment of various whitespace regions surrounding and in between lines of text and/or graphic objects.

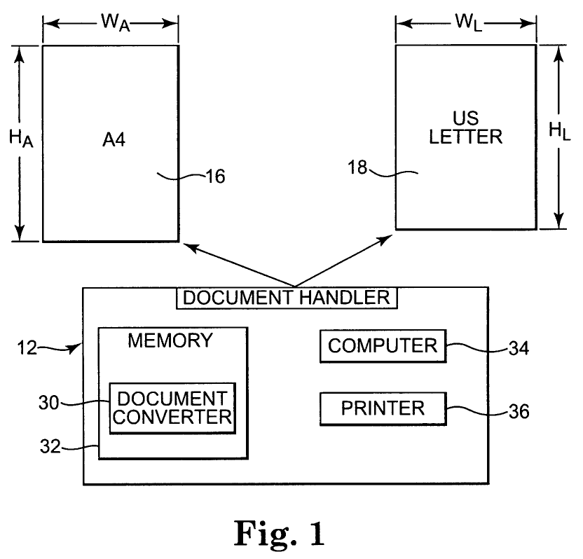

These embodiments of the invention, and additional embodiments of the invention, are described and illustrated throughout FIGS. 1-7.

FIG. 1 is a block diagram of a document handler 12, according to an embodiment of the invention. As shown in FIG. 1, document handler 12 comprises document converter 30 stored in memory 32. In one aspect, document converter 30 comprises a portion of a printer 36, including but not limited to, an on-board printer driver or printer firmware. In another aspect, document converter 30 comprises a portion of computer 34, including but not limited to, a document processing software or printer driver.

As shown in FIG. 1, document converter 30 converts a first size document to a second size document, or vice versa, while retaining the look and feel of the respective originally sized document. In one embodiment, a first document 16 comprises an A4 sized document and a second document 18 comprises a U.S. Letter sized document, which is a different size than first document 16. In one aspect, when embodied as a U.S. Letter, second document 18 has a width (W_{L}) and a height (H_{L}) while first document 16, as an A4 document, has a width (W_{A}) and a height (H_{A}) which are different than width (W_{L}) and height (H_{L}). In other embodiments, first document 16 and second document 18 comprise documents having sizes other than A4 or U.S. Letter.

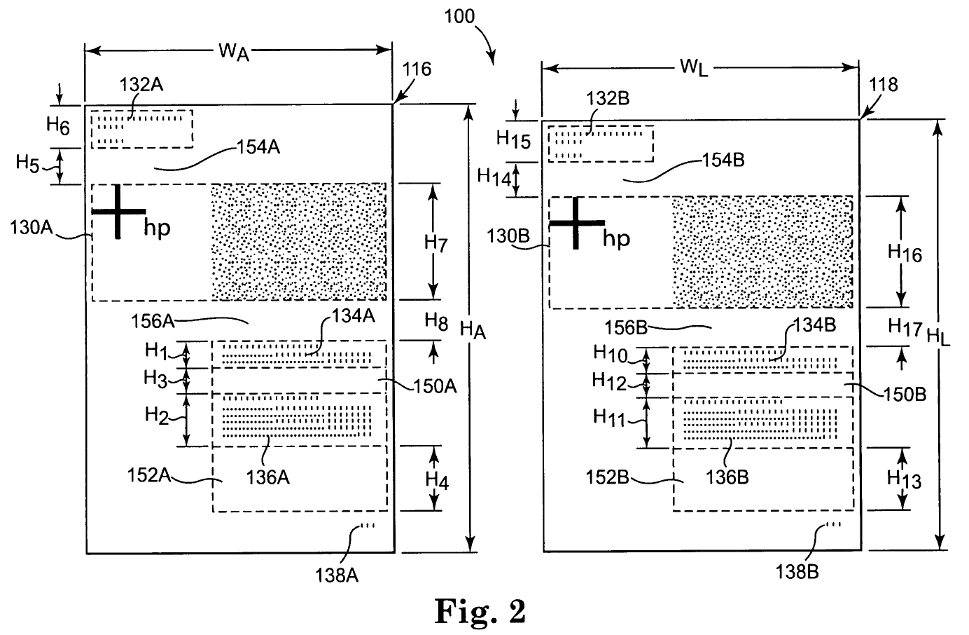

Operation of document converter 30, including illustrations of a conversion between first document 16 and second document 18, is described in more detail in association with FIGS. 2-7.

FIG. 2 is a diagram illustrating in detail one embodiment of a first size document 116 and a second size document 118. As shown in FIG. 2, first size document 116 has a width (W_{A}) and a height (H_{A}) and second size document 118 has a width (W_{L}) and height (H_{L}) which are different than width (W_{A}) and height (H_{A}). First size document 116 and second size document 118 are converted with respect to each other via document converter 30 (FIG. 1).

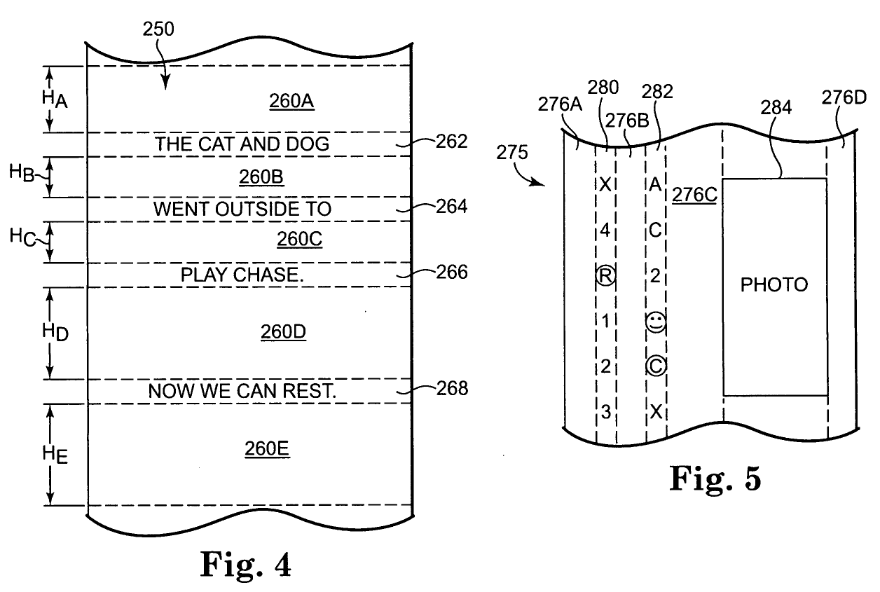

First size document 116 comprises numerous whitespace portions and non-white portions. For illustrative purposes, some of those portions are identified by dashed lines as non-white portions 130A, 132A, 134A, 136A, 138A, and whitespace portions 150A, 152A, 154A, 156A. However, the actual documents 116, 118 do not have dashed lines surrounding the respective text and/or objects. Instead, the dashed lines facilitate highlighting the relative sizes and positions of whitespace portions and non-white portions. Accordingly, in one aspect, the non-white portions comprise text 134A, 136A and/or graphic objects 130A, 138A that extend horizontally across the first size document and are vertically separated by the horizontally extending whitespace portions 150A, 152A, 154A, 156A of the first document 116. In another aspect, sections including multiple lines of text (e.g., portions 134A, 136A) are generally considered not to be objects but separate lines of text, as described further below in association with FIG. 2 and FIG. 4.

To convert between differently sized documents via document converter 30, the size of the whitespace portions 150A, 152A, 154A, 156A are modified (e.g., expanded or shrunk) according to the relative proportion of the height/width aspect ratios of the first size document 116 and the second size document 118, while maintaining the size (e.g., a height) of non-white portions 130A, 132A, 134A, 136A, 138A in the first size document. Once converted, second size document 118 has non-white portions 130B-136B that are the same vertical size as non-white portions 130A-136A and whitespace portions 150B-156B that have a different vertical size than whitespace portions 150A-156A. By distributing the page dimensional difference (i.e., the size difference between the first size document and the second size document along a single dimensional orientation for a single page) among the multiple white spaces throughout the page, this mechanism produces a resized document having the look and feel of the original size document.

As shown in the embodiment of FIG. 2, for illustrative purposes, non-white portions 134A and 136A in first document 116 are treated as single objects to illustrate their relationship relative to white portions 150A, 152A. However, in one aspect, each non-white portion 134A and 136A comprises a plurality of text lines with each text line comprising a non-white line with horizontal white lines vertically separating each text line (e.g., a non-white line), as further described in association with FIG. 4. Accordingly, for illustrative purposes, FIG. 2 does not show the adjustment of a vertical size of whitespace portions between immediately adjacent, vertically separated lines of text to emphasize the adjustment of white space portions between vertically adjacent non-white portions that result in a second size document 118 having modified whitespace portions 150B, 152B, 154B, and 156B between non-white portions 130B, 132B, 134B, 138B.

As shown in the embodiment of FIG. 2, portion 134A has a height H1 and portion 136A has a height H2 with whitespace portion 150A therebetween having a height H3. Whitespace portion 152A has a height H4, whitespace portion 154A has height H5 while non-white portion 132A has a height H6 and non-white portion 130A has a height H7.

Based on the previously described conversion, whitespace portions of first size document 116 are shrunk to produce a corresponding array of reduced whitespace portions in second size document 118. For example, in one aspect, height H3 of whitespace portion 150A in first size document 116 is reduced to height H12 of whitespace portion 150B in second size document 118. Height H4 of whitespace portion 152A in first size document 116 is reduced to height H13 of whitespace portion 152B in second size document 118. Height H5 of whitespace portion 154A in first size document 116 is reduced to height H14 of whitespace portion 154B in second size document 118. Height H8 of whitespace portion 156A in first size document 116 is reduced to height H17 of whitespace portion 156B in second size document 118.

However, at the same time that numerous white space portions are adjusted vertically, the vertical size of non-white portions is maintained. In particular, height H7 of non-white portion 130A is maintained (i.e., not adjusted) as reflected by substantially the same height H16 of non-white portion 130B. Height H1 of non-white portion 134A is maintained (i.e., not adjusted) as reflected by substantially the same height H10 of non-white portion 134B. Height H2 of non-white portion 136A is maintained (i.e., not adjusted) as reflected by substantially the same height H11 of non-white portion 136B. Height H6 of non-white portion 132A is maintained (i.e., not adjusted) as reflected by substantially the same height H15 of non-white portion 132B.

Accordingly, based on the modification of each horizontally extending whitespace portion 150A, 152A, 154A, 156A along a vertical dimensional orientation relative to horizontally extending non-white portions 130A, 132A, 134A, 136A, 138A, second size document has a height H_{L} and width W_{L} different than a respective height H_{A} and width W_{A} of first size document while retaining the look and feel of the first size document.

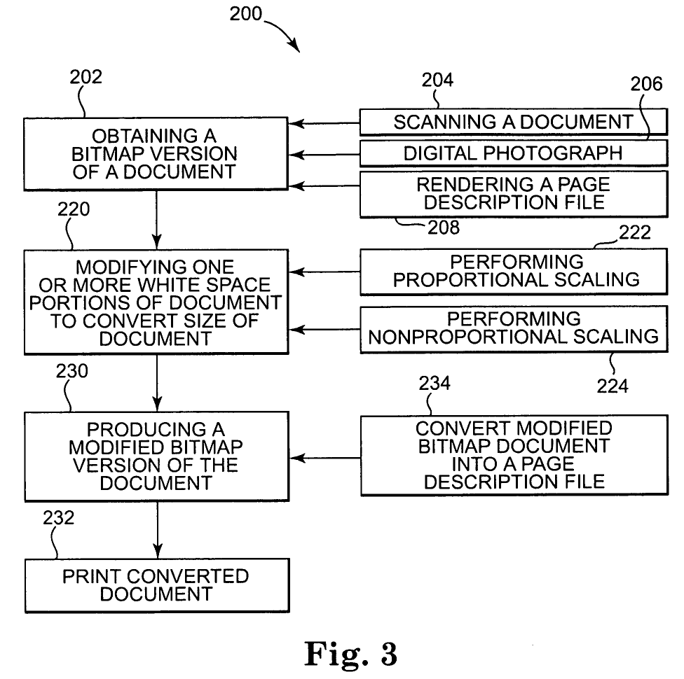

FIG. 3 is a flow diagram illustrating a method 200 of document resizing, according to an embodiment of the invention. As shown in FIG. 3, at 202 a bitmap version of a document is obtained, which is referred to as a bitmap document file. As shown at 204, 206, and 208, this bitmap document file is obtained in one of several different ways. In one aspect, at 204 a paper document is scanned to produce a bitmap document file. At 206, an object or document is digitally photographed to produce the bitmap document file. At 208, a page description file, such as a portable document file (PDF) or postscript file is rendered into a bitmap document file. Method 200 does not exclude other methods of obtaining a bitmap document file.

After obtaining a bitmap document file, at 220 the method comprises modifying one or more whitespace portions of the bitmap document file to convert the size of the bitmap document file while retaining the overall look and feel of the document.

This modification identified at 220 is performed in one of several different ways. In one aspect, at 222 the modification is performed via proportional scaling. In proportional scaling, whitespace portions are resized in proportion based on a height/width aspect ratio of one document relative to a height/width aspect ratio of a second document, while maintaining (i.e., not changing) a size of the non-white portions.

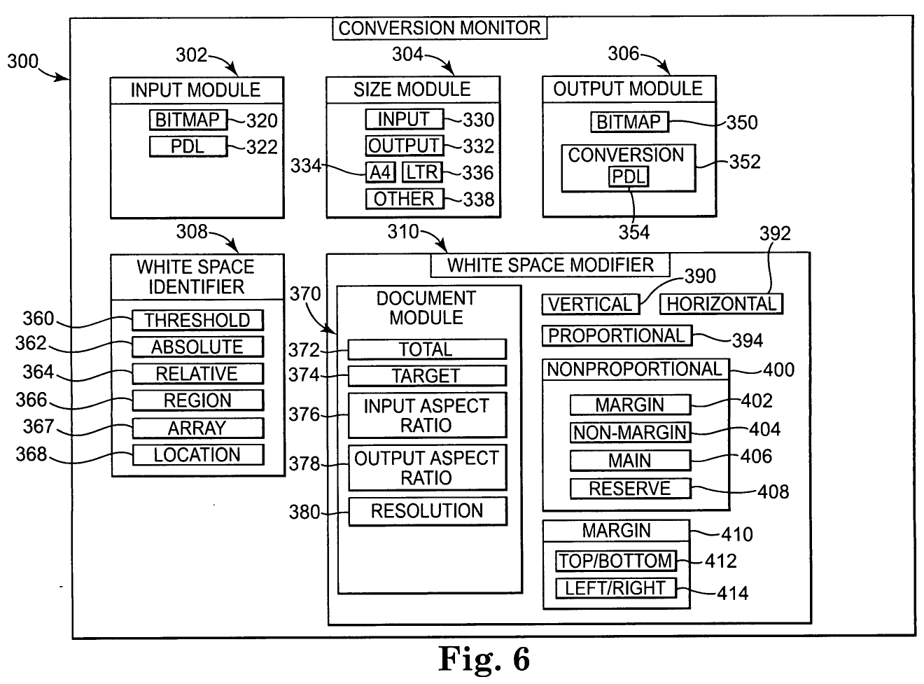

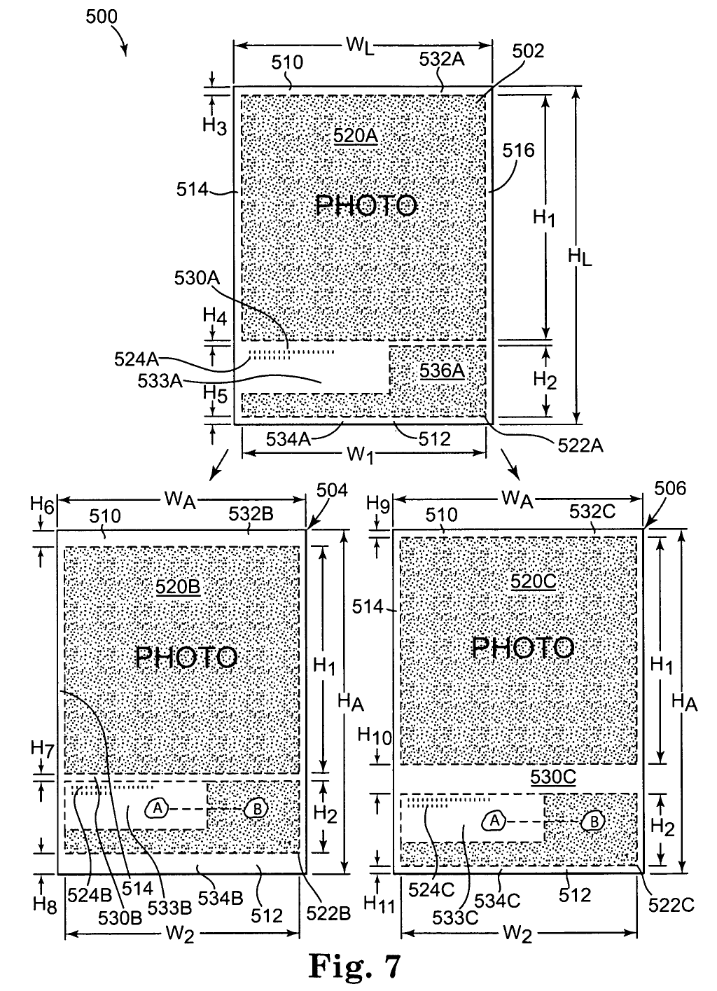

In another aspect, at 224 the modification is performed via non-proportional scaling. In one aspect of non-proportional scaling, margins of the document are excluded from identification as whitespace portions to be modified. Accordingly, the remaining portions of the document (i.e., every portion but the margins) are then analyzed to identify and modify all whitespace portions, while maintaining the size of the whitespace margins and maintaining the size of the non-white portions. The remaining whitespace portions are modified proportionally along a single dimensional orientation (e.g., a height or a width) based on a first height/width aspect ratio of the originally sized document relative to the second height/width aspect ratio of the new size document. Various aspects of proportional and non-proportional scaling are described in further detail in association with FIGS. 6-7.

In another embodiment, for a bitmap document file that originally was a portable document file (PDF), the adjustment information for modifying whitespace portions between adjacent objects in the bitmap document file is used to directly modify the positions of objects in the original PDF file to produce a resized PDF file. In one aspect, a source document like first size document 116 in FIG. 2 corresponds to a portable document file (PDF) having non-white portions 130A, 134A as objects of the source PDF document. After determining a size of whitespace adjustment to be made (e.g., adjusting whitespace portion 156A in FIG. 2) via a white versus non-white bitmap line analysis, instead of implementing a reduction or increase in the number of white lines for the whitespace portion (e.g., portion 156A) in the bitmap document file, the adjustment information is used to change the source PDF document by changing a distance between objects (e.g., objects 130A, 134A) in the source PDF document via direct resetting the position of the objects in the PDF language of the source PDF document file.

At 230, method 200 comprises producing a modified bitmap document file, which is converted into a page description file (e.g. PDF or postscript) at 234 and/or printed as a converted bitmap document at 232.

In another aspect, method 200 is applied to multiple page documents in which method 200 is applied to each page individually, and then resized document pages are reassembled for handling as single page description file or for immediate printing as a resized document.

In one embodiment, method 200 is performed using document converter 30 (including conversion monitor 300 of FIG. 6), as described in association with FIGS. 1-2, 4-7. In other embodiments, systems other than document converter 30 and/or conversion monitor 300 are used to perform method 200.

FIG. 4 is a schematic diagram illustrating one embodiment of a portion of a document. As shown in FIG. 4, document portion 250 comprises non-white portions 262, 264, 266, and 268, which are vertically separated by white portions 260B, 260C, 260D, respectively. Whitespace portions 260A and 260E are vertically disposed externally of non-white portions 262-268. In one embodiment, document portion 250 corresponds to one of portions 132A, 134A or 136A of first document 116 previously shown in FIG. 2.

Each whitespace portion 260A-260E is comprised of one or more bitmap lines that lack a non-white pixel (i.e., a line that has all white pixels) while each non-white portion is comprised of an vertical array of horizontal bitmap lines (e.g., that make up a single line of text) with each bitmap line including at least one non-white pixel in each horizontal bitmap line.

In one aspect, document portion 250 represents an instance of portion 132A, 134A, and 136A having non-white portions, such as lines of text, with intervening whitespace portions sandwiched between adjacent lines of text, as one typically finds in a text document having single spaced text or double spaced text. Accordingly, the features and attributes of resizing document portion 250 are applied to portions 132A, 134A, and 136A of first document 116 in FIG. 2.

Through application of method 200 and/or document converter 30 as applied in association with documents 116 and 118 of FIG. 2, a vertical dimension of whitespace portions 260A-260E (as represented by respective heights H_{A}-H_{E}) is modified in proportion to an height/width aspect ratio of a new size document relative to a current sized document while a vertical dimension of each line of text 262, 264, 266, 268 are not changed. The result is a newly sized document in which the lines of text remain in a general spaced relationship (e.g., single spaced, double spaced) with a subtle adjustment (expansion or shrinking) of whitespace portions between the adjacent lines of text according to the relative sizes of the document. Because the vertical dimension (height) of each line of text stays the same in this embodiment, each line of text does not become distorted in appearance as might occur in conventional resizing techniques.

Moreover, in embodiments of the invention, lines of text and/or graphic objects are not locked to a coordinate position, and the coordinate position of lines of text and/or objects are not used for repositioning. Instead, the text and/or graphic objects move in response to a resizing of each whitespace portion individually between respective adjacent lines of text or objects in which each whitespace portion is adjusted in proportion to a height/width scaling factor, such as an aspect ratio. This adjustment of each whitespace portion individually results in a proportional change over the whole document or document portion 250. Because only the whitespace portions are modified in size, no mechanism is necessary to vertically adjust a font size, or to a stretch or squeeze a font, to resize the document.

Accordingly, in resizing a document comprising large amounts of lines of text, the change in whitespace portions will be barely noticeable as the total adjustment of whitespace for the entire document is spread out between each adjacent pairs of lines of text. For example, if a document portion has lines of text with about 20 white bitmap lines between adjacent lines of text, and the document is resized (e.g., A4 to U.S. Letter), the resized document may have only 17 white bitmap lines in that whitespace portion. This change is barely perceptible, yet when carried out over an entire document or document portion, effectively resizes a text portion while maintaining its original look and feel. However, as will be illustrated further in association with FIG. 7, when a document has only a few whitespace portions (e.g., corresponding to larger objects in the document), a more noticeable change is seen in the adjusted size of the whitespace portions.

FIG. 5 is schematic illustration of one embodiment of a document 275 having text or characters arranged in vertical columns in a side-by-side relationship, such as a page of Asian language characters, along side a graphic object such as photograph. As shown in FIG. 5, document 275 comprises generally vertically extending non-white portions 280, 282, and 284 horizontally separated by vertically extending whitespace portions 276A, 276B, 276C and 276D. A method of resizing a document, that is substantially the same as method 200, is applied to document 275 except for being applied in an orientation in a different single dimension laterally across the document (e.g., horizontally) as compared to FIGS. 2 or FIG. 4.

Accordingly, the line-by-line analysis of a bitmap document file (as previously described in association with FIGS. 1-4) to identify each white line and non-white line is applied to document 275 of FIG. 5. Accordingly, in document 275, vertically extending whitespace portions are resized while maintaining a size of vertically extending non-white portions, except that vertically extending whitespace portions are resized rather than resizing horizontally extending whitespace portions as in FIG. 2.

In particular, as shown in the embodiment of FIG. 5, intervening whitespace portions, such as whitespace portions 276B and 276C, are adjusted in their horizontal dimensions laterally across document 275 relative to a height/width aspect ratio of a first size document and a height/width aspect ratio of a second differently sized document. At the same time, in a manner substantially the same as in the other embodiments, non-white portions 280, 282, and 284 are not resized along a horizontal dimensional orientation.

Accordingly, as illustrated by the embodiment of FIG. 5, and earlier FIGS. 1-4, whitespaces of a document are resized along either a horizontal dimensional orientation or a vertical dimensional orientation, depending upon the dimensional orientation of the text and/or objects in the document. Moreover, in one embodiment, use of resizing along a horizontal dimensional orientation is not restricted to Asian language text documents, but is applied to documents having only graphic objects as well as other arrangements of characters, symbols, text, objects that primarily have a vertically extending dimensional orientation with vertically extending intervening whitespace portions.

FIG. 6 is a block diagram of a conversion monitor 300, according to an embodiment of the invention. As shown in FIG. 6, conversion monitor 300 comprises input module 302, size module 304, output module 306, white space identifier 308, and white space modifier 310. In one embodiment, conversion monitor 300 enables substantially the same features and attributes already described for document converter 30 in association with FIGS. 1-5, as well as additional features and attributes.

Conversion monitor 300 comprises various modules and parameters that are selectable for activation to affect document resizing as previously described in association with FIGS. 1-5, 7, and in additional ways described in association with FIG. 6. In one embodiment, all modules and/or parameters of conversion monitor 300 are available and selectable for execution. In other embodiments, only some modules and/or parameters (but not others) are available or applied depending on the type of document being resized. Accordingly, in some embodiments, conversion monitor 300 does not include all modules and/or parameters shown in FIG. 6.

As shown in the embodiment of FIG. 6, input module 302 of conversion monitor 300 comprises bitmap parameter 320 and page description language file (PDL) parameter 322. Input module 302 enables control over or specifying the type of document file to be converted. Bitmap parameter 320 enables selection of bitmap document files for resizing, while page description language file parameter 322 enables page description language files, such as portable document files (PDF) or postscript files, to be converted in size by first converting the page description language files into bitmap document files via bitmap parameter 320. In one embodiment, input module 302 comprises a deskewing parameter to enable straightening an image in a bitmap document file prior to identifying whitespace portions.

As shown in the embodiment of FIG. 6, size module 304 of conversion monitor 300 comprises input size parameter 330, output size parameter 332, A4 size parameter 334, U.S Letter size parameter 336, and other size parameter 338. Size module 304 enables specifying a size of input document files (i.e., a first size document file to be converted) via input size parameter 330 and a size of output document files (i.e., a second size document file resulting from conversion of the first size document file) via output size parameter 332. A4 size parameter 334 enables specifying an A4 document size (e.g., a document having height of about 11⅔ inches and a width of about 8¼ inches) as an input document size or an output document size for size module 304. U.S. Letter parameter enables specifying a United States (U.S.) document size (e.g., a document having height of 11 inches and a width of 8½ inches) as an input document size or an output document size for size module 304.

In one embodiment, input size parameter 330 and output size parameter 332 are set automatically. For example, capture hardware or page description files can indicate the size of the source document size to conversion monitor 300. If the source document size (i.e., input document size) is very close to that of U.S. Letter size, size module 304 will then directly set the output document size to the A4 size. Likewise, if the source document size is very close to that of A4 size, size module 304 will then directly set the output document size to U.S. Letter. In other embodiments, as described above, the input size and the output size are manually set.

In one embodiment, other size parameter 338 enables specifying a size other than A4 or U.S. Letter as either an input document size or an output document size.

As shown in the embodiment of FIG. 6, output module 306 of conversion monitor 300 comprises bitmap parameter 350 and conversion parameter 352 with page description file parameter 354. Output module 306 enables control over the type of document file that is produced upon conversion of a first size document file to a second size document file. Bitmap parameter 350 enables specifying production of a bitmap document file while page description language file (PDL) parameter 354 enables specifying rendering a bitmap document file into portable document file (PDF) format or a postscript file to enable saving the file or other manipulations of those files besides printing of the second size document file as a bitmap file.

As shown in the embodiment of FIG. 6, white space identifier 308 of conversion monitor 300 comprises threshold parameter 360, absolute parameter 362, relative parameter 364, region parameter 366, array parameter 367, and location parameter 368. White space identifier 308 controls how document conversion monitor 300 identifies white space portions within a bitmap document file. Threshold parameter 360 enables specifying a grey-level threshold against which a grey-level value of each pixel of the bitmap document file will be compared to determine whether a bitmap line will be considered a white line or a non-white line. In one embodiment, a white line is defined as a bitmap line having all white pixels. In one aspect, a white pixel is a pixel value having an RGB value of 255, 255, 255 (e.g., generally equivalent to a CYMK value of 0,0,0,0).

In one embodiment, threshold parameter 360 also includes a pixel quantity parameter to select that a value (e.g., 1, 2, 3, or 4 or more) that defines a minimum number of non-white pixels that must be present to determine that a bitmap line is a non-white line. In one embodiment, a non-white line is defined as a bitmap line having at least one non-white pixel. In one aspect, a non-white pixel is any pixel having a RGB value other than 255, 255, 255 (or a CMYK value other than 0,0,0,0).

In another aspect, threshold parameter 360 enables defining what is considered a white pixel or a non-white pixel on a grey-level basis via absolute parameter 362. Absolute parameter 362 enables setting the grey-level threshold as an absolute value, such as RGB of 250, 250, 250 (or other RGB values). In one example, a pixel having a RGB value of 252, 252, 252 is defined as a white pixel by an operator that selects this RGB value as being a substantially white pixel as measured on a grey-level intensity scale. Pixels having a RGB value above 252, such as a RGB value of 253, 253, 253 are deemed white pixels while pixels below 252 (e.g., 150, 150, 150) are deemed non-white pixels. This example is illustrative with many different grey-level values (as expressed via RGB values or other grey-level intensity identifiers) being selectable to define a white versus non-white threshold.

In one embodiment, relative parameter 364 of whitespace identifier 308 is used instead of absolute parameter 362 to enable control over comparing pixels relative to each other by a quantity. In one aspect, for example, a bitmap line having a pixel having a grey-level intensity value more than 200 or 90 percent darker than an adjacent bitmap line is defined as a non-white pixel, and therefore a non-white line.

Region parameter 366 of whitespace identifier 308 enables setting a different grey-level threshold for separate regions of the first size document file. In one aspect, a first grey-level threshold for determining white lines and non-white lines is set for a first region of the first size document file while a second grey-level threshold for determining white lines and non-white lines is set for a second region of the first size document file. In another aspect, more than two different regions with respectively different grey-level thresholds are set. Accordingly, region parameter 366 enables treating different portions of a document by different threshold criteria to enable an operator to account for different characteristics of a document.

Array parameter 367 tracks identified white lines to enable grouping of contiguously (or substantially contiguously) adjacent white lines together into an array. In one aspect, an array of contiguously adjacent white lines is defined as a white space portion or a white run. In another aspect, a single white line is defined as a white space portion. In another embodiment, array parameter 367 determines the number of contiguously adjacent white lines that are defined as a white space portion eligible to be modified in size. In one embodiment, groups of white lines less than a defined threshold of white lines (e.g., one line, two lines) are not modified in size while groups of white lines that exceed the threshold (e.g., 10 contiguous white lines) are modified in size. In another embodiment, any group of white lines (e.g., two lines) is eligible to be modified in size regardless of the size of the group of contiguously adjacent white lines. Accordingly, array parameter 367 facilitates determining whether or not a white space portion is modified depending on a relative size of documents and the number and/or size of the other white space portions.

In some applications, location parameter 368 of whitespace identifier 308 is activated to track an absolute or relative location of one or more whitespace portions on a bitmap document file.

As shown in the embodiment of FIG. 6, white space modifier 310 of conversion monitor 300 comprises document module 370, vertical parameter 390, horizontal parameter 392, proportional parameter 394, non-proportional module 400 and margin module 410. White space modifier 310 enables control over how whitespaces within a first size document file are modified (i.e., increased or decreased) to convert to a differently sized document file (e.g., converting A4 to U.S. Letter).

Document module 370 of whitespace modifier 310 comprises total parameter 372, target parameter 374, input aspect ratio parameter 376, output aspect ratio parameter 378, and resolution parameter 380. Total parameter 372 tracks the total whitespace portions or non-white portions of an entire bitmap document file. Target parameter 372 tracks adjustment of the whitespace portions identified (i.e., targeted for modification) via whitespace identifier module 308. Input aspect ratio parameter 376 enables selective control of a height/width aspect ratio of an input size document file while output aspect ratio parameter 378 enables selective control a height/width aspect ratio of an output size document file. In one aspect, parameters 376, 378 enable manual entry of a height and width of respective input and output document files. In another aspect, these parameters store or automatically obtain a height and width of respective input and output document files. In one embodiment, resolution parameter 380 enables specifying a resolution of the bitmap document file (e.g., a scanning capture resolution) for use in combination with aspect ratios to effect desired scaling.

Vertical parameter 390 of whitespace modifier 310 enables selecting that whitespace adjustments are made based on a vertical dimension of horizontally extending white portions between horizontally extending non-white portions. This parameter enables modifying U.S. Letter and A4 documents using language styles comprising generally horizontal lines of text vertically separated by generally horizontal white lines or graphic objects that are vertically separated by generally horizontal white spaces.

Horizontal parameter 392 of whitespace modifier 310 enables selecting that whitespace adjustments are made based on a horizontal dimension of vertically extending white portions between vertically extending non-white portions. This parameter enables resizing differently sized documents (e.g., A4, U.S. Letter, other size) using character-based language styles, such as Asian languages (e.g., Chinese, Japanese, etc.) comprising generally vertical lines of text horizontally separated by generally vertical white lines. This parameter also enables resizing documents having graphic objects horizontally separated by vertically extending whitespace portions. One application of horizontal parameter 392 is described in association with FIG. 5.

Proportional scaling parameter 394 of whitespace modifier 310 controls modifying (e.g., increasing or decreasing) white space portions of a bitmap document file based on a proportion, along a single dimensional orientation, of a size of an input document file relative to an output document file. In one aspect, this relative proportion is based on a first height/width aspect ratio of the input size document file and a second height/width aspect ratio of the output size document file. In another aspect, this relative proportion is further based on a resolution of the bitmap document file, via resolution parameter 380, in combination with the first and second height/width aspect ratios. In another embodiment, proportional scaling is performed based on other mechanisms that account for a relative proportion of the height and width of the input size document file and the output size document file.

Non-proportional scaling module 400 of whitespace modifier 310 comprises margin parameter 402, non-margin parameter 404, main parameter 406, and reserve parameter 408. Margin module 410 comprises top/bottom parameter 412 and left/right parameter 414.

In one embodiment, non-proportional scaling parameter module 400 enables resizing a document using a technique in which a portion of the bitmap document file is not resized on a proportional scaling basis as with proportional scaling parameter 394. In one aspect, margin parameter 402 enables specifying that the size of one or more margins (e.g., margins that define a whitespace portion) of the input size document file will not be adjusted. Accordingly, all non-margin portions of the input size document file will be adjusted for the size of their whitespace portions according to some form of proportional scaling, such as proportional scaling parameter 394. This embodiment is also referred to as margin-priority scaling because the margins defining whitespace portions are treated separately from the remainder of the document in relation to identifying and modifying whitespace portions. Features of non-proportional scaling, via margin parameter 402, are described in more detail in association with FIG. 7, along with an illustration of proportional scaling (enabled by proportional scaling parameter 394).

In another embodiment, main parameter 406 and reserve parameter 408 of non-proportional scaling module 400 enable selecting which portions of input size document file are treated with proportional scaling. In one aspect, main parameter 406 selects main portions of a document to be proportionally scaled while reserve parameter 408 selects other portions of document to be maintained at their current size.

Margin module 410 of whitespace modifier 310 enables control over whether margins of an input size document file will be treated as whitespace portions, or selectively treated as non-white portions for special applications at the discretion of an operator. Top/bottom margin 412 controls selection of top and/or bottom margins for discretionary treatment as non-white portions and left/right margin 412 controls selection of top and/or bottom margins for discretionary treatment as non-white portions.

In another embodiment of resizing documents, when the original bitmap document file is obtained from a digital camera or a scanner, white space modifier 310 of conversion monitor 300 applies an image sampling algorithm, such as linear or cubic interpolation, to recreate a resized whitespace portion according to a relative proportion between the size of the original document file and the size of the new sized document file.

Accordingly, conversion monitor 300 comprises numerous parameters and modules for selecting and controlling various aspects of resizing a document, according to embodiments of the invention.

FIG. 7 is a diagram illustrating one embodiment of a comparison 500 of results of a method of resizing a document 502, via the embodiments described in association with FIGS. 1-6, according to proportional scaling to produce a first resized document 504 and according to margin-priority scaling to produce a second resized document 506.

As shown in the embodiment of FIG. 7, document 502 comprises a top margin 510, bottom margin 512, left margin 514, and right margin 516. Document 502 also includes first graphic portion 520A, second graphic portion 522A, and lines-of-text portion 524A. An intervening white space portion 530A is disposed between first graphic portion 520A and both lines-of-text portion 524A and second graphic portion 522A. An upper whitespace portion 532A corresponds generally to top margin 510A of document 502 while a lower whitespace portion 534A corresponds generally to bottom margin 512 of document 502. Left margin 514 and right margin 516 also correspond to vertically extending whitespace portions, but are not adjusted in this embodiment of the invention which focuses on resizing whitespace portions along a vertical dimensional orientation.

In addition, a secondary whitespace portion 533A (also represented by identifier A in documents 504 and 506) is located between lines-of-text portion 524A and second graphic portion 522A and is generally parallel (i.e., extending on the same generally horizontal lines) to an upper portion 536A of second graphic portion 522A (also represented by identifier B in documents 504 and 506).

When analyzed on a line-by-line basis, no size adjustment is made for secondary whitespace portion 533A because upper portion 536A of second graphic portion 522A is a non-white region including an array of generally horizontal non-white lines that are generally horizontally parallel to (i.e., generally in a side-by-side, spaced relationship) bitmap lines as secondary whitespace portion 533A. Accordingly, despite the relatively large secondary white portion 533A, this vertical size of this portion 533A is not modified (increased or decreased) to enable proportional scaling of the document as a whole.

As shown in the embodiment of FIG. 7, document 504 and document 506 represents a resizing of document 502 from a U.S. Letter size to an A4 size. Whitespace portions 530A, 532A and 534A are adjusted relative to non-whitespace portions 520A and 522A based on a proportion of the size of document 502 relative to a size of document 504. In one aspect, the adjustment is made based on a proportion of a height/width aspect ratio of document 502 relative to a height/width aspect ratio of document 504.

In one embodiment of document resizing, as revealed by a comparison of document 502 and document 504, whitespace portion 532B, white space portion 534B (which correspond to a top margin 510 and a bottom margin 512), and whitespace portion 530B of document 504, have been increased in vertical size relative to whitespace portions 530A, 534A and 532A of document 502, respectively. Accordingly, height H3 of whitespace portion 532A, height H4 of whitespace portion 530A, and height H5 of whitespace portion 534A in document 502 are increased, respectively, to a larger height H6 of whitespace portion 532B, a larger height H7 of whitespace portion 530B, and a larger height H8 of whitespace portion 534B. Meanwhile, height H1 of non-white portion 520A and height H2 of non-white portion 522A in document 502 are not changed in size and therefore remain at the same height H1 for non-white portion 520B and height H2 of non-white portion 522B, although their relative position has changed in response to adjustment of the vertical size of whitespace portions 530B, 532B, and 534B.

In another embodiment of document resizing, as revealed by a comparison of document 502 and resized document 506, a vertical size of whitespace portion 532C and white space portion 534C, which correspond to a top margin and a bottom margin, have been maintained at their original size in document 502. In other words, no adjustment (e.g., increase or decrease) in the vertical dimension of white space portions 532A and 534A have been made. Instead, whitespace portion 530A of document 502 has been increased to a larger vertical size as reflected by whitespace portion 530C of document 506. In this embodiment, the vertical size of top margin and bottom margin are set to generally equal their original vertical size, and then the remainder of the document is resized in proportion to the relative sizes of document 502 and document 506. Accordingly, this embodiment performs margin-priority scaling in which the margins of the document are first reserved to maintain their size, prior to performing proportional scaling over the remainder of the document. In one aspect, this feature is enabled by activation of margin parameter 402 and/or reserve parameter 404 in non-proportional scaling module 400 of document conversion monitor 300. In one aspect, this embodiment is considered non-proportional scaling because the whole document is not scaled by a single proportional model. In another aspect, this embodiment applies proportional scaling after first prioritizing the margins for different treatment.

In one aspect, height H4 of whitespace portion 530A in document 502 is increased to a larger height H10 of whitespace portion 530C. Meanwhile, height H3 of whitespace portion 532A and height H5 of whitespace portion 534A in document 502 are not changed in size and therefore remain at the same height H9 for whitespace portion 532C and height H11 of whitespace portion 534C. Meanwhile, height H1 of non-white portion 520A and height H2 of non-white portion 522A in document 502 are not changed in size and therefore remain at the same height H1 for non-white portion 520C and height H2 of non-white portion 522C, although their relative position has changed in response to adjustment of the vertical size of whitespace portion 530C.

Accordingly, whitespace portions 532C and 534C are not vertically resized relative to whitespace portions 532A, 534A, while whitespace portion 530C of resized document 506 reflects vertical resizing (e.g., an increase) of whitespace portion 530A in document 502.

This margin-priority embodiment enables preserving the look and feel of a document (e.g., document 502) with a focus on preserving the appearance of the top margin and bottom margin of the document. In other instances, the margins of the document are less important to reflecting the look and feel of the original document and accordingly, proportional scaling as shown in document 504 is applied, which focuses on preserving the appearance of central regions of the document 502 while giving less importance to replication of the top and bottom margins as they appeared in the original document 502.

Embodiments of the invention enable resizing an originally sized document to a different sized document while preserving a look and feel of the contents, such as text or graphic objects, of the originally sized document. The document conversion is performed automatically without coordinate repositioning of text or objects and without performing active adjustments in both dimensional orientations (e.g., both height and width) of a document file. The conversion takes place with bitmap document files in a manner not requiring manual adjustment of the document, after conversion of the documents, by the user.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of resizing documents comprising:
obtaining a first bitmap document file corresponding to a first size document;
identifying, in a single dimensional orientation, at least one whitespace portion between adjacent non-white portions in the first bitmap document file; and
adjusting, in the single dimensional orientation, a size of the at least one whitespace portion in the first bitmap document file while maintaining a size of the non-white portions in the single dimensional orientation, to produce a second bitmap document file corresponding to a second size document having a different size than the first size document.

2. The method of claim 1 wherein identifying and adjusting the at least one whitespace portion in the single dimensional orientation comprises:
altering a vertical dimension of the at least one whitespace portion between the adjacent non-white portions.

3. The method of claim 1 wherein identifying and adjusting the at least one whitespace portion in the single dimensional orientation comprises:
altering a horizontal dimension of the at least one whitespace portion between the adjacent non-white portions.

4. The method of claim 1 wherein obtaining the first bitmap document file comprises producing the bitmap document file via at least one of:
scanning a paper document;
rasterizing a page description file; and
digitally photographing an object.

5. The method of claim 1 wherein adjusting the at least one whitespace portion comprises:
modifying the size of the at least one whitespace portion based on a proportion of a first height/width aspect ratio of the first size document relative to the second height/width aspect ratio of the second size document.

6. The method of claim 5 wherein modifying the size of the at least one whitespace portion comprises:
reserving from modification at least one whitespace margin of the first bitmap document file along the single dimensional orientation.

7. The method of claim 5 wherein modifying the size of the at least one whitespace portion comprises:
altering the size of the at least one whitespace portion based on a capture resolution in combination with the first height/width aspect ratio and the second height/width aspect ratio.

8. The method of claim 5 wherein modifying the size of the at least one whitespace portion comprises:
directly modifying a position of at least one object in a source portable document file that corresponds to the first bitmap document file.

9. The method of claim 1 wherein adjusting the at least one whitespace portion comprises:
increasing the size of the at least one whitespace portion to produce the second size document as an A4 size document from an U.S. Letter size document.

10. The method of claim 1 wherein adjusting the at least one whitespace portion comprises:
decreasing the size of the at least one whitespace portion to produce the second size document as an U.S. Letter size document from an A4 size document.

11. The method of claim 1 wherein identifying at least one whitespace portion comprises:
designating as a non-white line, from among lines of the first bitmap document file, each line of the first bitmap document file that includes at least one pixel that exceeds a grey-level threshold;
designating as a white line, from among lines of the first bitmap document file, each line that is not a non-white line; and
grouping together each white line between adjacent pairs of non-white lines to form the at least one whitespace portion.

12. The method of claim 11 and further comprising:
defining the grey-level threshold in a first region of the first bitmap document file to have a first value; and
defining the grey-level threshold in a second region of the first bitmap file to have a second value different than the first value.

13. A document resizer module comprising:
a white line identifier configured to identify each non-white bitmap line on a first size bitmap document file relative to each white bitmap line and to group each plurality of white bitmap lines that are contiguously adjacent each other into a white line segment; and
a space adjuster configured to alter a single dimensional size of each white line segment, based on a relative size of the first size bitmap document file and the second size bitmap document file while not altering a single dimensional size of non-white bitmap lines, to modify the first size bitmap document file into the second size bitmap document file.

14. The document resizer of claim 13 wherein the whiteline identifier comprises:
a non-white pixel identifier including a pixel quantity parameter and a grey-level threshold parameter, the non-white pixel identifier configured to identify each bitmap line of the first size bitmap document file that includes at least one pixel that has a grey-level intensity exceeding the grey-level threshold parameter wherein the at least one pixel exceeds the pixel quantity parameter.

15. The document resizer module of claim 13 wherein the space adjuster comprises:
a proportional scaling parameter to adjust the single dimensional size of each white line segment based on a proportion of a height and a width of the first size bitmap document file relative to the second size bitmap document file.

16. The document resizer module of claim 13 wherein the space adjuster comprises:
a margin priority parameter to maintain the single dimensional size, in the second size bitmap document file, of a first white line segment comprising a top margin and a second white line segment comprising a bottom margin of the first size bitmap document file.

17. A printer system comprising:
means for converting a first size document file to a second size document file having a size different than the first size document file via adjusting a size of a whitespace region in a single dimensional orientation of the first size document file while maintaining a size of a non-white region in the single dimensional orientation of the first size document file to produce the second size document file; and
means for printing the second size document file.

18. The printer system of claim 17 wherein the means for converting comprises:
a white line identifier configured to examine each bitmap line of a bitmap version of the first size document file to designate each bitmap line that includes at least one pixel having a grey-level value exceeding a grey-level threshold parameter as a fixed bitmap line and to designate all other bitmap lines of the first size document file as a variable bitmap line.

19. The printer system of claim 18 wherein the means for converting comprises:
a space adjuster configured to produce the second size document file by maintaining a number of, and a size of, fixed bitmap lines in the single directional dimension while modifying a number of variable bitmap lines based on an height/width aspect ratio of the first size document file relative to the second size document file.

20. A computer-readable medium having computer-executable instructions for performing a method of resizing documents, the method comprising:
obtaining a first bitmap document file corresponding to a first size document;
identifying, in a single dimensional orientation, at least one whitespace portion between adjacent non-white portions in the first bitmap document file; and
adjusting, in the single dimensional orientation, a size of the at least one whitespace portion in the first bitmap document file based on a proportion of a first height/width aspect ratio of the first size document relative to a second height/width aspect ratio of a second size document, to produce the second bitmap document file corresponding to a second size document having a different size than the first size document.
